(19) United States
(12) Patent Application Publication
(10) Pub. No.: US 2013/0233190 A1
(43) Pub. Date: Sep. 12, 2013

(54) LITHOGRAPHIC IMAGING AND PRINTING WITH POSITIVE-WORKING PHOTORESPONSIVE PRINTING MEMBERS

(71) Applicants: Frederick Richard Kearney, Walpole, MA (US); Kevin Ray, Windham, NH (US)

(72) Inventors: Frederick Richard Kearney, Walpole, MA (US); Kevin Ray, Windham, NH (US)

(73) Assignee: Presstek, Inc., Hudson, NH (US)

(21) Appl. No.: 13/413,281

(22) Filed: Mar. 6, 2012

(51) Int. Cl. B41N 1/08; B41N 3/00

(52) U.S. Cl. 101/457; 101/467

(57) ABSTRACT

Imaging of positive-working, IR-sensitive printing plates that use a novolac resin as the major polymer component of the imaging layer takes place with greater post-exposure latitude. In various embodiments, the imaging layer includes one or more poly(vinyl phenol) polymers or copolymers combined with one or more vinyl phenol monomers.

### BACKGROUND OF THE INVENTION

In offset lithography, a printable image is present on a printing member as a pattern of ink-accepting (oleophilic) and ink-rejecting (oleophobic) surface areas. Once applied to these areas, ink can be efficiently transferred to a recording medium in the imagewise pattern with substantial fidelity. In a wet lithographic system, the non-image areas are hydrophilic, and the necessary ink-repellency is provided by an initial application of a dampening fluid to the plate prior to inking. The dampening fluid prevents ink from adhering to the non-image areas, but does not affect the oleophilic character of the image areas. Ink applied uniformly to the wetted printing member is transferred to the recording medium only in the imagewise pattern. Typically, the printing member first makes contact with a compliant intermediate surface called a blanket cylinder which, in turn, applies the image to the paper or other recording medium. In typical sheet-fed press systems, the recording medium is pinned to an impression cylinder, which brings it into contact with the blanket cylinder.

To circumvent the cumbersome photographic development, plate-mounting, and plate-registration operations that typify traditional printing technologies, practitioners have developed electronic alternatives that store the imagewise pattern in digital form and impress the pattern directly onto the plate. Plate-imaging devices amenable to computer control include various forms of lasers.

In positive-working plates, the background (as opposed to foreground or image) areas of the plate are the ones that receive exposure to a laser or other source of imaging radiation. The effect of radiation exposure depends on the nature of the plate. For example, where plates are “developed” by subjecting them to the action of a liquid developer following exposure, radiation either “fixes” the topmost layer to render it resistant to the developer (which washes away the unexposed areas) or has the opposite effect, rendering an otherwise developer-resistant layer vulnerable to developer action. Suppose the plate is configured for wet printing and has two layers, an oleophilic layer to receive ink and a hydrophilic layer to receive fountain solution or other aqueous liquid that repels subsequently applied ink; the ink-receiving areas are foreground or image layers, and areas that do not receive ink are considered background. Because the plate is positive-working, the radiation either renders the oleophilic layer removable by development or fixes the hydrophilic layer against removal. Most positive-working wet plates utilize the former mechanism.

For example, a topmost oleophilic, photoresponsive layer may be sensitized to light in the near infrared (IR) region, thus allowing the use of a modulated near-IR laser to imagewise write a developable pattern on the photoresponsive coating. The substrate may be aluminum with an anodized oxide layer to provide a hydrophilic and mechanically durable surface. Once exposed, the plate is treated with a developing liquid to remove those areas that have received exposure while leaving the unexposed areas unaffected. Removal of the oleophilic photoresponsive coating reveals the hydrophilic aluminum layer, which will serve as the background and reject ink during printing.

Positive-working formulations may be made developable by inducing changes in the dissolution rate of resins—e.g., alkali-soluble resins if an alkaline developer is to be used—that make up the bulk of their composition. This change may be effected by the imagewise application of thermal energy, e.g., the absorption of near-IR radiation by a dye which, in turn, converts the absorbed energy into heat. These resins typically contain a substantial amount of phenolic groups, which have a pKa on the order of 10 and consequently are typically soluble in alkaline solutions with a pH between 12 and 13. The composition also typically includes dissolution-inhibiting additives that lower the dissolution rate of the unexposed coating, providing better retention of the developed image area without unduly sacrificing the sensitivity of the photoresponsive layer. In these systems, the change in responsiveness to the developer is physical rather than chemical, and as a result, the change is reversible: over time, the dissolution rate of the imaged area of the coating can and does revert to a slower-dissolving form, i.e., the plate becomes partially or wholly undevelopable. For this reason, positive-working IR-sensitive printing plates may exhibit a short working time between imaging and development. The maximum allowable working time before toning (i.e., unwanted ink receptivity in background plate areas) occurs is called the “post-exposure latitude.” Consequences of short post-exposure latitude can include loss of plates, toning on the printed sheet, and problems with accurately calibrating both platesetters for the imaging media and plate-developing machines.

Accordingly, there is a need for positive-working wet plates that exhibit adequate sensitivity to imaging radiation while providing improved post-exposure latitude.

### SUMMARY OF THE INVENTION

The present invention is directed toward improving working times for positive-working, IR-sensitive printing plates that use a phenolic resin (most often a novolac) as the major polymer component of the imaging layer. It has been found, surprisingly, that in additive amounts (1 to 25%), one or more poly(vinyl phenol) (PVPh) polymers or copolymers combined with one or more vinyl phenol monomers markedly improve the post-exposure latitude of novolac-based plates. The result is surprising because PVPh's are themselves too developer-soluble to serve as the bulk imaging-layer polymer.

In general, printing members according to the invention include a hydrophilic layer (which may serve as the substrate) and an oleophilic photoresponsive layer including an alkali-soluble novolac resin; a polymer or copolymer including vinyl phenol monomer; and a material that absorbs imaging radiation and converts it to heat, e.g., a near-IR absorbing dye.

Accordingly, in a first aspect, the invention pertains to a method of imaging a lithographic printing member. Embodiments of the method involve providing a lithographic printing member comprising a hydrophilic first layer and, disposed over the first layer, an oleophilic imaging layer having (i) a resin phase consisting essentially of a major amount of alkali-soluble novolac resin and a minor amount of vinyl phenol component including one or more poly(vinyl phenol) polymers or copolymers combined with one or more vinyl phenol monomers, the vinyl phenol component being present in an amount ranging from 1% to 25% by weight of dry film, and (ii) dispersed within the cured resin phase, a near-IR absorber. The printing member is exposed to infrared imaging radiation in an imagewise pattern to render the imaging layer vulnerable to the action of a developer where so exposed; and is thereupon subjected member to a developer to remove only exposed portions of the imaging layer.

In various embodiments the imaging radiation has fluence between 100 and 250 mJ/cm², e.g., between 125 and 200 mJ/cm². The developer may have a pH between 12.5 and 14. The printing member may include one or more of the following features. The first layer of the printing member may be an aluminum sheet. The near-IR absorber may be a dye present at a level ranging from 0.5 to 5% of dry film. The alkali-soluble novolac resin a cresol novolac resin, or may be a novolac based on cresol and at least one other monomer. The vinyl phenol component may consist essentially of a homopolymer or copolymer of 4-vinylphenol. It may be present in an amount ranging from 2.5% to 7.5% by weight of dry film. The oleophilic imaging layer may further comprise a development inhibitor and/or a visible dye.

In another aspect, the invention relates to a lithographic printing member. In various embodiments the printing member a hydrophilic first layer; and disposed over the first layer, an oleophilic imaging layer having (i) a resin phase consisting essentially of a major amount of alkali-soluble novolac resin and a minor amount of vinyl phenol component including one or more poly(vinyl phenol) polymers or copolymers combined with one or more vinyl phenol monomers, the vinyl phenol component being present in an amount ranging from 1% to 25% by weight of dry film, and (ii) dispersed within the cured resin phase, a near-IR absorber. The printing member may include one or more of the following features. The first layer of the printing member may be an aluminum sheet. The near-IR absorber may be a dye present at a level ranging from 0.5 to 5% of dry film. The alkali-soluble novolac resin a cresol novolac resin, or may be a novolac based on cresol and at least one other monomer. The vinyl phenol component may consist essentially of a homopolymer or copolymer of 4-vinylphenol. It may be present in an amount ranging from 2.5% to 7.5% by weight of dry film. The oleophilic imaging layer may further comprise a development inhibitor and/or a visible dye.

It should be stressed that, as used herein, the term “plate” or “member” refers to any type of printing member or surface capable of recording an image defined by regions exhibiting differential affinities for ink and/or fountain solution. Suitable configurations include the traditional planar or curved lithographic plates that are mounted on the plate cylinder of a printing press, but can also include seamless cylinders (e.g., the roll surface of a plate cylinder), an endless belt, or other arrangement.

Furthermore, the term “hydrophilic” is used in the printing sense to connote a surface affinity for a fluid which prevents ink from adhering thereto. Such fluids include water for conventional ink systems, aqueous and non-aqueous dampening liquids, and the non-ink phase of single-fluid ink systems. Thus, a hydrophilic surface in accordance herewith exhibits preferential affinity for any of these materials relative to oil-based materials.

The term “substantially” means±10% (e.g., by weight or by volume), and in some embodiments, ±5%. The term “consists essentially of” means excluding other materials that contribute to function or structure. For example, a resin phase consisting essentially of a major amount of alkali-soluble novolac resin and a minor amount of one or more poly(vinyl phenol) polymers or copolymers combined with one or more vinyl phenol monomers may include other ingredients, such as a catalyst, that may perform important functions but do not constitute part of the polymer structure of the resin. Percentages refer to weight percentages unless otherwise indicated.

### DESCRIPTION OF DRAWINGS

The foregoing discussion will be understood more readily from the following detailed description of the disclosed technology, when taken in conjunction with the single FIGURE of the drawing, which is an enlarged cross-sectional view of a positive-working printing member according to the invention.

### DETAILED DESCRIPTION

### 1. Imaging Apparatus and Plate Development

The coated plate is imaged in an imaging device, typically by means of a modulated signal, e.g., a modulated near-IR laser. The laser is rastered over the plate surface while the laser intensity is modulated according to digital information so that only the background areas of the plate receive exposure. An imaging apparatus suitable for use in conjunction with the present printing members includes at least one laser device that emits in the region of maximum plate responsiveness, i.e., whose λₘₐₓ closely approximates the wavelength region where the plate absorbs most strongly. Specifications for lasers that emit in the near infrared (IR) region are fully described in U.S. Pat. Nos. Re. 35,512 (“the '512 patent”) and 5,385,092 (“the '092 patent”), the entire disclosures of which are hereby incorporated by reference. Lasers emitting in other regions of the electromagnetic spectrum are well-known to those skilled in the art.

Suitable imaging configurations are also set forth in detail in the '512 and '092 patents. Briefly, laser output can be provided directly to the plate surface via lenses or other beam-guiding components, or transmitted to the surface of a blank printing plate from a remotely sited laser using a fiber-optic cable. A controller and associated positioning hardware maintain the beam output at a precise orientation with respect to the plate surface, scan the output over the surface, and activate the laser at positions adjacent selected points or areas of the plate. The controller responds to incoming image signals corresponding to the original document or picture being copied onto the plate to produce a precise negative or positive image of that original. The image signals are stored as a bitmap data file on a computer. Such files may be generated by a raster image processor (“RIP”) or other suitable means. For example, a RIP can accept input data in page-description language, which defines all of the features required to be transferred onto the printing plate, or as a combination of page-description language and one or more image data files. The bitmaps are constructed to define the hue of the color as well as screen frequencies and angles.

The level of the exposure depends on the power of the laser, the size of the laser spot, and the composition of the coating, but is preferably chosen to deliver an area energy density or fluence between 100 and 250 mJ/cm², and more preferably between 125 and 200 mJ/cm². Examples of suitable exposure devices are the COMPASS 8030 and the DIMENSION PRO 800, both provided by Presstek Inc. Other imaging systems, such as those involving light valving and similar arrangements, can also be employed; see, e.g., U.S. Pat. Nos. 4,577,932; 5,517,359; 5,802,034; and 5,861,992, the entire disclosures of which are hereby incorporated by reference. Moreover, it should also be noted that image spots may be applied in an adjacent or in an overlapping fashion.

The imaging device is typically integrated into a platemaker, which exposes the plates, and following exposure, the plate is transferred to a processor that subjects it to the action of a suitable alkaline developer to remove the exposed portions of the imageable coating. The pH of the developer is sufficiently alkaline to dissolve a phenolic resin of the cresol novolac type, with typical formulations having a pH between 12.5 and 14, and more preferably between 13 and 13.5. Suitable developer formulations known to those skilled in the art, and various commercially available products may be used herewith. Among these are GOLDSTAR PREMIUM developer from Eastman Kodak and AEON Developer from Presstek Inc. The developer is used at a controlled temperature between 20 and 26° C., preferably between 22 and 24° C. The plate is immersed in the developer, optionally with agitation, for a sufficient time to dissolve the imaged coating but without dissolving the unexposed coating. Typical development immersion times range from 15 to 60 seconds, more preferably from 20 to 30 seconds. After development, the residual developer is rinsed off the plate surface and the plate is dried before use. Optionally, a plate storage gum may be applied after rinsing to protect the hydrophilic surface exposed by development. A plate thus developed (and optionally gummed) may be mounted on a lithographic printing press and run with commercial inks and fountain solutions to produce printed sheets of desirable quality over several thousand impressions.

### 2. Lithographic Printing Members

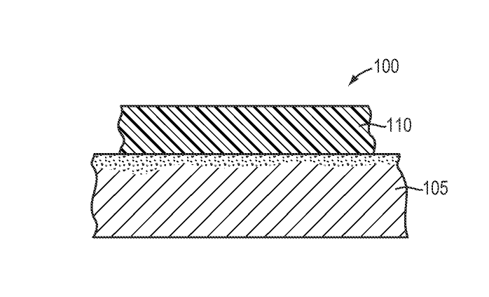

FIG. 1 illustrates a positive-working printing member 100 according to the invention that includes a a hydrophilic substrate 105 and an oleophilic photoresponsive layer 110. Layer 110 is sensitive to imaging (generally IR) radiation as discussed below, and imaging of the printing member 100 (by exposure to IR radiation) heats layer 110, rendering the layer soluble when subjected to a developer. Where not exposed to imaging radiation, layer 110 is resistant to removal by the developer. Most or all of the layers used in the present invention are continuous. The term “continuous” as used herein means that the underlying surface is completely covered with a uniform layer of the deposited material. Each of the layers and its functions are described in detail below.

2.1 Substrate 105

The substrate provides dimensionally stable mechanical support to the printing member. The substrate should be strong, stable, and flexible. One or more surfaces (and, in some cases, bulk components) of the substrate is hydrophilic, and the substrate itself is desirably metal. In general, metal layers undergo special treatment in order to be capable of accepting fountain solution in a printing environment. Any number of chemical or electrical techniques, in some cases assisted by the use of fine abrasives to roughen the surface, may be employed for this purpose. For example, electrograining involves immersion of two opposed aluminum plates (or one plate and a suitable counterelectrode) in an electrolytic cell and passing alternating current between them. The result of this process is a finely pitted surface topography that readily adsorbs water. See, e.g., U.S. Pat. No. 4,087,341.

A structured or grained surface can also be produced by controlled oxidation, a process commonly called “anodizing.” An anodized aluminum substrate consists of an unmodified base layer and a porous, “anodic” aluminum oxide coating thereover; this coating readily accepts water. Without further treatment, however, the oxide coating would lose wettability due to further chemical reaction. Anodized plates are, therefore, typically exposed to a silicate solution or other suitable (e.g., phosphate) reagent that stabilizes the hydrophilic character of the plate surface. In the case of silicate treatment, the surface may assume the properties of a molecular sieve with a high affinity for molecules of a definite size and shape—including, most importantly, water molecules. The treated surface also promotes adhesion to an overlying photopolymer layer. Anodizing and silicate treatment processes are described in U.S. Pat. Nos. 3,181,461 and 3,902,976. Poly(vinyl phosphonic acid) post-anodic treatment is particularly preferred.

Preferred hydrophilic substrate materials include aluminum that has been mechanically, chemically, and/or electrically grained with subsequent anodization. The surface of substrate 105 has characteristics matched to performance of the overlying layer. The thickness of substrate 105 generally ranges from 0.004 to 0.02 inch, with thicknesses in the range 0.005 to 0.012 inch being particularly preferred.

In other embodiments, the hydrophilic surface is provided by a layer that does not itself serve as a substrate—e.g., which is laminated or coated onto a heavier substrate layer.

2.2 Photoresponsive Layer 110

Layer 110 is typically applied as a coating and includes an alkali-soluble novolac resin; a polymer or copolymer including vinyl phenol monomer; and a material that absorbs imaging radiation and converts it to heat, e.g., a near-IR absorbing dye.

The radiation absorber is present in sufficient amounts to sensitize the coating to laser radiation produced by a laser. In the case of a dye, the amount utilized in layer 110 depends on the light absorptivity of the dye and the desired sensitivity of the coating, but typical use levels are between 0.5 and 5% of the dry film solids. The dye is preferably dissolved in the solvent for the coating layer, but a different solvent can be used as long as that solvent is not incompatible with the rest of the photoresponsive layer composition. Dyes with a high absorption coefficient at the imaging laser wavelength are preferred; a high absorption coefficient at 830 nm is especially preferred. Representative dyes include, but are not limited to, S0094 from FEW Chemicals, ADS830AT from American Dye Source, and IR 822 from Hampford Research.

The coating formulation of layer 110 includes a phenolic resin, preferably a novolac resin, and more preferably a cresol novolac resin; but novolacs based on cresol and other monomers such as phenol or xylenol can be used to optimize the layer properties, such as photospeed in the imaged area or developer resistance in the unexposed area. The molecular weight of the novolac resin is not particularly critical, and any novolac suitable for positive plates can be used (with suitable adjustments of the remaining components to produce the desired imaging response). A single novolac resin can be used, but two or more can also be used in combination to optimize the performance of the photosensitive layer. Optimal relative amounts of several novolac resins can be determined from imaging performance by those skilled in the art. The phenolic resin or resins make up the bulk of the coating not occupied by other components. Examples of useful phenolic resins include, but are not limited to, SPN 452 (AZ Electronic Materials), PD-140A, D_PD-1640, D_PD-1646 (Momentive Specialty Materials), and other similar resins. Relevant properties of PD-140A and D_PD-1640 include:

| | Bulk Dissolution Rate | Solution Viscosity, | |
|---|---|---|---|
| Product | (\acute{Å}/sec) | cSt | Typical Mw |
| PD-140A | 750 ± 100 | 41-49 | 6000-9000 |
| D_PD-1640 | 700 ± 100 | 72-86 | 16000-23000 |

where the solution viscosity is for a 30% PMA solution at 25° C. PD-140A, for example, is a high-purity cresol formaldehyde novolac resin based primarily on meta-cresol and para-cresol, and with the chemical formula

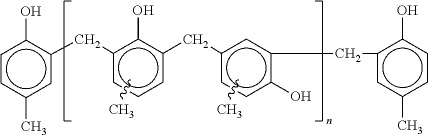

The coating includes a homopolymer of 4-vinylphenol (Structure 1), or a copolymer of 4-vinylphenol with one or more other common monomers such as vinyl pyrrolidone, butyl acrylate, styrene, methyl methacrylate, and/or 2-hydroxyethyl acrylate; the selection of comonomers is not particularly critical.

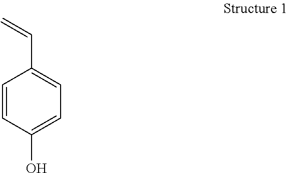

It is surprisingly found that when a small amount of poly(4-vinyl phenol) or one of its copolymers is added to the photosensitive layer composition, the post-exposure latitude of the imaging layer is improved compared with the use of other phenolic resins alone. The PVPh is preferably soluble in the primary solvent used to prepare the photoresponsive coating 110, and is preferably compatible with the phenolic resin used in the coating. The vinyl phenol polymer may be linear or branched, and may be a homopolymer or a copolymer with other monomers that are familiar to those skilled in the art of polymerization; the nature of the homopolymer or copolymer is not particularly critical, as long as it contains vinyl phenol monomer.

The vinyl phenol polymer is preferably added to the composition from in the range of 1 to 25% by weight of dry film solids, more preferably from 2.5 to 20% of dry film solids and especially from 2.5 to 7.5% of dry film solids. Less than 1% PVPh provides no obvious benefit, and more than 25% promotes attack of the unexposed photoresponsive layer in the development step.

Optionally, a visible dye may be added to improve the visual quality of the imaged and developed plate for inspection purposes. The amount of dye included in the coating depends on the desired optical density, but typical use levels are between 1 and 5% of the dry film solids, more preferably between 1 and 3%.

Additional materials (i.e., development inhibitors) can be added to improve the development resistance of the unexposed layer. Examples of development inhibitors include aromatic ketones, organosulfonate esters, silicones, cyclic azines such as benzoxazines, onium salts, and several other molecular species. Particularly preferred are onium salts, silicones, and benzoxazines. The proportion of these additives can vary from 1% to 15%, depending on the type of dissolution inhibitor. Furthermore, surfactants can be added to the coating to improve the coating quality and uniformity of the coated layer. Silicone polyether surfactants, such as are commercially produced by Evonik and Byk-Chemie, are preferred. The surfactants are used in amounts sufficient to provide good wetting of the substrate and leveling of the dry coating, typically on the order of 0.01-0.1% of the total coating composition of 0.1-1% of the dry film solids.

Layer 110 is deposited on the hydrophilic surface of layer 105 by dissolving the components of the coating in one or more common solvents at a known concentration, and then coating the solution by any of various known coating methods (such as wire-wound rod coating, reverse roll coating, gravure coating, or slot die coating) to provide the desired coating deposit per unit area. Common solvents for the components of this composition include ketones, esters, aromatic hydrocarbons, and mixtures thereof, provided that all solvents are capable of dissolving all components of the composition at their use level in the coating. The concentration and wet-film weight of the coating are chosen to provide a dry coating thickness to produce an imageable layer that has a desirable imaging sensitivity, but retains a sufficient thickness in unexposed areas following development to perform adequately over an expected lifetime in a commercial printing environment. The coating deposit is preferably between 1 and 3 g/m², and more preferably between 1.5 and 2 g/m². The concentration of the coating fluid and the method of coating fluid application on the substrate are chosen to produce the desired coating deposit. The layer 110 is fully dried (i.e., solid) following plate manufacture.

### 3. Imaging and Printing

Where exposed to imaging radiation, layer 110 absorbs the imaging pulse and converts it to heat. The heat diffuses through layer 110 and effects physical changes that render the coating removable by a developer. Without being bound by any theory or mechanism, it is believed that a hydrogen-bonded, thermally frangible complex is formed between the novolac resin and the near-IR absorber, the visible dye (if present) and even the optional additional materials. The complex is reversibly formed and can be broken by application of heat, which restores developer solubility to the imaging layer. It is not thought that decomposition of components within the imaging layer is required, or that any substantial decomposition has occurred in any examples tested to date. After imaging, the portions of layer 110 that have received radiation are removed by subjection to a developer. The developer is typically applied to the printing member in a processor equipped with an immersion-type developing bath, a section for rinsing with water, a gumming section, and a drying section. Development may conveniently be carried out in a commercially available immersion-type processor such as the PK910 MARK II processor; the Mercury MARK V processor (both Eastman Kodak, Rochester N.Y.); the Global Graphics TITANIUM processor (Global Graphics, Trenton, N.J., USA); the Glunz and Jensen QUARTZ 85 processor (Glunz and Jensen, Elkwood, Va., USA) and the TPP (Aeon-style) processor from Presstek Inc.

The imaged and developed printing member can also be baked in a post-bake operation that can be carried out to increase run length on a printing press. Baking can be carried out, for example, at from about 160° C. to about 260° C. for from about 1 to about 10 minutes, especially from about 1 to 4 minutes.

Printing with the printing member includes applying dampening solution to the plate followed by ink, which is thereby transferred in the imagewise lithographic pattern (created as described above) to a recording medium such as paper. The inking and transferring steps may be repeated a desired number of times, e.g., up to 50,0000 or more times.

### EXAMPLES

In the examples that follow, the phenolic resins indicated in Table 1 were employed.

TABLE 1
Phenolic Resins

| | | | | | | | |
|---|---|---|---|---|---|---|---|
| | | | | | | | Bulk |
| | | | | | | Mw/Mn (if | Dissolution |
| Resin | Vendor | Delivery form | Chemical Type | Monomer balance | MW (g/mol) | known) | Rate, Å, sec |

[symbol]

Electronic Materials

| | | | | | | |
|---|---|---|---|---|---|---|
| SPN 452 | AZ Electronic Materials | 40% in Dowanol PM | mixed phenolic | m/p/xylenoles | 16000-20000 | 139 |

Momentive Specialty Materials

| | | | | | | |
|---|---|---|---|---|---|---|
| D_PD-1646 | Momentive/Hexion | solid | cresol novolac | unknown | 9000-16000 | 142.25 |

[symbol]

indicates data missing or illegible when filed

In most experiments, PVPh refers to product PEND, a poly(vinyl phenol) homopolymer from DuPont Electronic Materials. Other vinyl phenol polymers are listed in the following table (where MW refers to molecular weight generally, M_{W} refers to weight-average molecular weight and M_{N} refers to number-average molecular weight). All vinyl phenol polymers listed were obtained from DuPont Electronic Materials.

TABLE 2
Vinyl phenol polymers

| Resin | Polymer Type | MW | M_{w}/Mₙ |
|---|---|---|---|
| P8ND | homopolymer, linear | 12,300 | 1.95 |
| P25ED | homopolymer, linear | 22,500 | 1.70 |
| PB5E | homopolymer, branched | 5,593 | 1.72 |

### Examples 1-5

The following coating compositions were mixed from stock solutions to produce the coating fluids in Table 3. All stock solutions were prepared in 2-methoxypropanol (Dowanol PM) except for the IR dye S0094, which was prepared in diacetone alcohol.

TABLE 3
Coating fluids for Examples 1-5

| | | | | | |
|---|---|---|---|---|---|
| | Compara- | | | | |
| Stock | tive | Exam- | Exam- | Exam- | Exam- |
| % | Example 1 | ple 2 | ple 3 | ple 4 | ple 5 |

Reagent

| | | | | | | |
|---|---|---|---|---|---|---|
| SPN 452 | 41.7 | 10.61 | 10.08 | 9.55 | 9.02 | 8.49 |
| P8ND (PVPh) | 20 | 0.00 | 1.11 | 2.21 | 3.32 | 4.43 |
| S 0094 | 2 | 7.50 | 7.50 | 7.50 | 7.50 | 7.50 |
| Vic Blue BO | 2 | 5.00 | 5.00 | 5.00 | 5.00 | 5.00 |
| Tego Glide 410 | 5 | 0.50 | 0.50 | 0.50 | 0.50 | 0.50 |
| Silikoftal HTT | 10 | 2.00 | 2.00 | 2.00 | 2.00 | 2.00 |
| Irgacure 250 | 10 | 1.00 | 1.00 | 1.00 | 1.00 | 1.00 |
| Dowanol PM | | 23.39 | 22.81 | 22.24 | 21.66 | 21.09 |
| total mass | | 50 | 50 | 50 | 50 | 50 |
| % solids | | 10 | 10 | 10 | 10 | 10 |
| solid mass | | 5 | 5 | 5 | 5 | 5 |
| % cosolvent | | 0 | 0 | 0 | 0 | 0 |

Dry film % solids

| | | | | | |
|---|---|---|---|---|---|
| SPN 452 | 88.5 | 84.075 | 79.65 | 75.22 | 70.8 |
| P8ND (PVPh) | 0 | 4.425 | 8.85 | 13.28 | 17.7 |
| S 0094 | 3 | 3 | 3 | 3 | 3 |
| Vic Blue BO | 2 | 2 | 2 | 2 | 2 |
| Tego Glide 410 | 0.5 | 0.5 | 0.5 | 0.5 | 0.5 |
| Silikoftal HTT | 4 | 4 | 4 | 4 | 4 |
| Irgacure 250 | 2 | 2 | 2 | 2 | 2 |

The near-IR absorbing dye employed was S0094 from FEW Chemicals (although ADS830AT from American Dye Source and IR822 from Hampford Research can be used interchangeably). VICTORIA PURE BLUE BO is a solvent blue dye that was acquired from Aldrich Chemical. SILIKOFTAL HTT is a 75% silicone/aliphatic polyester copolymer solution, from Evonik Industries. TEGO GLIDE 410 is a silicone surfactant from Evonik, under the Tego label. IRGACURE 250 is a 75% solution of a diaryliodonium salt in propylene carbonate, provided by Ciba Specialty Materials.

The fluids were coated on an electrochemically grained and anodized 0.011″ thick aluminum plate that had received a poly(vinylphosphonic acid) (PVPA) post-anodic treatment (aluminum characteristics: rₐ=0.645 μm, r_{q}=0.804 μm, r_{z}=5.82 μm, surface volume=0.88 μm³, core roughness (Rₖ)=2.026 μm, reduced peak height (Rₚₖ)=0.464 μm, reduced valley depth (Rᵥₖ)=0.994 μm). The imaging layer was coated using a #7 coating rod (about 1.6 g/m² dry coat weight) and dried in a forced air oven for 43 seconds at 195° F. The plate was then subsequently heated in a 50° C. oven for 48 hours.

The seasoned plates were imaged in a Kodak TRENDSETTER 3244 with the imaging drum rotating at 175 rpm, and with the imaging power varied between 7 and 15 W. Imaging targets included 100% exposure, an 8×8 checkerboard (equivalent to 212 lines per inch) and a 2×2 checkerboard. The imaged plate was developed without a time delay in a two-brush AEON processor with brush one disengaged, using AEON Developer from Presstek Inc. The development temperature was 24° C., and the dip-to-nip immersion time was 24 seconds. The plate was rinsed with water after development and dried without an application of storage gum. Dot reproduction was measured after development with an ICPlatereader II (Gretag Macbeth, New Windsor, N.Y.). Dₘᵢₙ was measured with a Gretag D19C densitometer. The imaging sensitivies of coatings resulting from the different formulations were as follows:

TABLE 4
Imaging sensitivity data for Examples 1-5

| | Clearing Point | | Watts (W) to achieve a |
|---|---|---|---|
| Formulation | W | mJ/cm² | 50% dot at 212 lpi |
| Comparative Example 1 | >15 | >209 | — |
| Example 2 | 15 | 209 | — |
| Example 3 | 11.5 | 160 | 12.5 |
| Example 4 | 10 | 140 | 11.5 |
| Example 5 | 10 | 140 | 10.5 |

The clearing point is defined as the minimum exposure dose required to achieve full development of the coating. Compositions comprising increasing poly(vinyl phenol) produced increasingly sensitive imaging. For each of Examples 3, 4 and 5, a second plate was imaged at the measured dose to produce a 50% dot, and this image was developed at 1 and 2 hours after exposure. The post-exposure latitudes were as follows:

TABLE 5
Post-exposure latitude for Examples 3-5

| | | | 50% Dots |
|---|---|---|---|
| Formulation | Time (min) | Background | at 212 lpi |
| Example 3 | 0 | OK | 49.8 |
| Example 3 | 30 | OK | 51.8 |
| Example 3 | 60 | undeveloped | NA |
| Example 4 | 0 | OK | 49.8 |
| Example 4 | 60 | OK | 49.0 |
| Example 4 | 120 | OK | 49.6 |
| Example 5 | 0 | OK | 50.3 |
| Example 5 | 60 | OK | 50.6 |
| Example 5 | 120 | OK | 50.2 |

The formulation of Example 3 has sufficient image stability to maintain clean development up to 1 hour. Those of Examples 4 and 5 were stable for 2 hours or more.

### Examples 6-10

Several compositions were prepared according to formulation Table 6 below: they were coated, dried and seasoned in the same manner as Examples 1-5, also on the same PVPA-treated substrate.

TABLE 6
Formulations for Examples 6-10

| | Stock | Exam- | Exam- | Exam- | Exam- | Exam- |
|---|---|---|---|---|---|---|
| Reagent | % | ple 6 | ple 7 | ple 8 | ple 9 | ple 10 |
| SPN 452 | 41.7 | 7.73 | 7.51 | 7.28 | 5.16 | 5.01 |
| P8ND (PVPh) | 20 | 0.63 | 1.25 | 1.88 | 0.63 | 1.25 |
| D_PD-1646 | 30 | 3.58 | 3.48 | 3.38 | 7.17 | 6.96 |
| S 0094 | 2 | 7.50 | 7.50 | 7.50 | 7.50 | 7.50 |
| Vic Blue BO | 2 | 5.00 | 5.00 | 5.00 | 5.00 | 5.00 |
| Tego Glide 410 | 5 | 0.50 | 0.50 | 0.50 | 0.50 | 0.50 |
| Silikoftal HTT | 10 | 2.00 | 2.00 | 2.00 | 2.00 | 2.00 |
| Irgacure 250 | 10 | 1.00 | 1.00 | 1.00 | 1.00 | 1.00 |
| Dowanol PM | | 22.06 | 21.76 | 21.47 | 21.05 | 20.79 |
| total mass | | 50 | 50 | 50 | 50 | 50 |
| % solids | | 10 | 10 | 10 | 10 | 10 |

These plates were then subjected to the same power series exposure in the TRENDSETTER and development with AEON developer as listed in Examples 1-5. The imaging sensitivity for each coating is shown in the following table.

TABLE 7
Imaging Sensitivity for Examples 6-10

| | |
|---|---|
| Clearing | |
| Point | W to achieve a |

| Formulation | W | mJ/cm² | 50% dot at 212 lpi |
|---|---|---|---|
| Example 6 | 12 | 174 | 12 |
| Example 7 | 11 | 160 | 11 |
| Example 8 | 8 | 112 | 9.5 |
| Example 9 | 11 | 160 | 11 |
| Example 10 | 9 | 126 | 9 |

Again, compositions comprising increasing poly(vinyl phenol) were increasingly sensitive to imaging radiation for a given level of D_PD-1646 resin. Additional samples were exposed at optimal power levels for the formation of 50% dots, and then developed with increasing time delay between imaging and development. Development response was measured in actual % area of 8×8 dots, along with the cyan density of the 100% imaged area (Dₘᵢₙ/plate background). The results are tabulated below in Table 8.

TABLE 8
Post-exposure latitude for Examples 6-10

| | T = | T = | T = | T = | T = | T = | Exposure |
|---|---|---|---|---|---|---|---|
| Formulation | 0 | 1 hr | 2 hr | 4 hr | 6 hr | 8 hr | (W) |
| | 8 × 8 50% | | | | | | |
| Example 6 | 50.4 | Plugged | | | | | 12 |
| Example 7 | 49.8 | 50.6 | Plugged | | | | 11 |
| Example 8 | 50.2 | 50.7 | 50.5 | 51.2 | 51.3 | 53 | 9.5 |
| Example 9 | 49.4 | 49.5 | 50.1 | 50.2 | 50.7 | 50.6 | 11 |
| Example 10 | 49.9 | 50.1 | 50.2 | 50.9 | 51.1 | 51.4 | 9 |
| | Dmin (100% Exposure) | | | | | | |
| Example 6 | 0 | 0.02 | 0.24 | 0.5 | 0.56 | 0.58 | 12 |
| Example 7 | 0 | 0 | 0.01 | 0.25 | 0.48 | 0.51 | 11 |
| Example 8 | 0 | 0 | 0.02 | 0.01 | 0.01 | 0.02 | 9.5 |
| Example 9 | 0 | 0 | 0 | 0 | 0 | 0 | 11 |
| Example 10 | 0 | 0 | 0.01 | 0.01 | 0 | 0.01 | 9 |

Examples 6 and 7 exhibited 1 to 2 hours or less of image stability as measured by Dₘᵢₙ and 50% dot areas (PVPh content is low at 2.5 or 5% of the dry film). In contrast, Example 8 had a post-exposure stability of nearly 8 hours with increasing PVPh level (PVPh comprising 7.5% of the dry film). Example 9 (increased presence of D_PD-1646 resin and only 2.5% PVPh in dry film) exhibited stability on the order of 8 hours or more; the same was true of Example 10 (with 5% PVPh). A comparative example without PVPh yielded less than 1 hour of post-exposure latitude.

### Examples 11-19

Several compositions were prepared according to formulation Table 9 below. These were coated, dried and conditioned in the same manner as Examples 1-5, also on the same PVPA-treated substrate.

TABLE 9
Coating Fluids for Examples 11-19

| | | | | | | |
|---|---|---|---|---|---|---|
| Stock | Exam- | Exam- | Exam- | Exam- | Exam- | Exam- |
| % | ple 11 | ple 12 | ple 13 | ple 14 | ple 15 | ple 16 |

Reagent

| | | | | | | | |
|---|---|---|---|---|---|---|---|
| SPN 452 | 41.7 | 7.22 | 7.01 | 6.80 | 6.87 | 6.68 | 6.47 |
| P8ND (PVPh) | 20 | 0.63 | 1.25 | 1.88 | 0.63 | 1.25 | 1.88 |
| D_PD-1646 | 30 | 4.30 | 4.18 | 4.05 | 4.78 | 4.64 | 4.50 |
| S 0094 | 2 | 7.50 | 7.50 | 7.50 | 7.50 | 7.50 | 7.50 |
| Vic Blue BO | 2 | 5.00 | 5.00 | 5.00 | 5.00 | 5.00 | 5.00 |
| Tego Glide 410 | 5 | 0.50 | 0.50 | 0.50 | 0.50 | 0.50 | 0.50 |
| Silikoftal HTT | 10 | 2.00 | 2.00 | 2.00 | 2.00 | 2.00 | 2.00 |
| Irgacure 250 | 10 | 1.00 | 1.00 | 1.00 | 1.00 | 1.00 | 1.00 |
| Dowanol PM | | 21.86 | 21.57 | 21.28 | 21.72 | 21.44 | 21.15 |
| total mass | | 50 | 50 | 50 | 50 | 50 | 50 |
| % solids | | 10 | 10 | 10 | 10 | 10 | 10 |
| solid mass | | 5 | 5 | 5 | 5 | 5 | 5 |
| % cosolvent | | 0 | 0 | 0 | 0 | 0 | 0 |

Dry film % solids

| | | | | | | |
|---|---|---|---|---|---|---|
| SPN 452 | 60.2 | 58.45 | 56.7 | 57.33 | 55.67 | 54 |
| P8ND (PVPh) | 2.5 | 5 | 7.5 | 2.5 | 5 | 7.5 |
| D_PD-1646 | 25.8 | 25.05 | 24.3 | 28.67 | 27.83 | 27 |
| S 0094 | 3 | 3 | 3 | 3 | 3 | 3 |
| Vic Blue BO | 2 | 2 | 2 | 2 | 2 | 2 |
| Tego Glide 410 | 0.5 | 0.5 | 0.5 | 0.5 | 0.5 | 0.5 |
| Silikoftal HTT | 4 | 4 | 4 | 4 | 4 | 4 |
| Irgacure 250 | 2 | 2 | 2 | 2 | 2 | 2 |

| | | Example | Example | Example |
|---|---|---|---|---|
| | Stock % | 17 | 18 | 19 |
| Reagent | | | | |
| SPN 452 | 41.7 | 6.20 | 6.01 | 5.83 |
| P8ND (PVPh) | 20 | 0.63 | 1.25 | 1.88 |
| D_PD-1646 | 30 | 5.72 | 5.57 | 5.40 |
| S 0094 | 2 | 7.50 | 7.50 | 7.50 |
| Vic Blue BO | 2 | 5.00 | 5.00 | 5.00 |
| Tego Glide 410 | 5 | 0.50 | 0.50 | 0.50 |
| Silikoftal HTT | 10 | 2.00 | 2.00 | 2.00 |
| Irgacure 250 | 10 | 1.00 | 1.00 | 1.00 |
| Dowanol PM | | 21.46 | 21.18 | 20.90 |
| total mass | | 50 | 50 | 50 |
| % solids | | 10 | 10 | 10 |
| solid mass | | 5 | 5 | 5 |
| % cosolvent | | 0 | 0 | 0 |
| Dry film % solids | | | | |
| SPN 452 | | 51.7 | 50.1 | 48.6 |
| P8ND (PVPh) | | 2.5 | 5 | 7.5 |
| D_PD-1646 | | 34.3 | 33.4 | 32.4 |
| S 0094 | | 3 | 3 | 3 |
| Vic Blue BO | | 2 | 2 | 2 |
| Tego Glide 410 | | 0.5 | 0.5 | 0.5 |
| Silikoftal HTT | | 4 | 4 | 4 |
| Irgacure 250 | | 2 | 2 | 2 |

These plates were subjected to the same power series exposure in the TRENDSETTER platemaker and development with AEON developer as set forth in connection with Examples 1-5. The imaging sensitivity for each coating is set forth in the following table.

TABLE 10
Imaging Sensitivities for Examples 11-19

| | |
|---|---|
| Clearing Point | 50% dot reading |

| Formulation | W | mJ/cm² | at 12 W |
|---|---|---|---|
| Example 11 | 12 | 167 | 50.0 |
| Example 12 | 11 | 153 | 49.2 |
| Example 13 | 9 | 126 | 47.7 |
| Example 14 | 10.5 | 147 | 49.6 |
| Example 15 | 11 | 153 | 48.4 |
| Example 16 | 9 | 126 | 46.0 |
| Example 17 | 11 | 153 | 48.5 |
| Example 18 | 10 | 140 | 48.6 |
| Example 19 | 8 | 112 | 43.3 |

Generally, the clearing point decreases with increasing levels of PVPh for a given level of D_PD-1646. An optimal imaging power was chosen on the basis of the clearing point and the 50% dot reading, and a second set of plates with the same coating were imaged and then developed at fixed intervals from the exposure time to determine the post-exposure latitude. The results of this test are shown in Table 11.

TABLE 11
Post-exposure latitude for Examples 11-19

| | 8 × 8 50% Equivalent to 212 lpi | | | | | | | |
|---|---|---|---|---|---|---|---|---|
| | | | | | | | Time before | |
| | | | | | | | background not | Exposure |
| Formulation | T = 0 | T = 1 hr | T = 2 hr | T = 4 hr | T = 6 hr | T = 8 hr | developed (hr) | (W) |
| Example 11 | 49.8 | 49.8 | 49.8 | 49.8 | 49.9 | plugged | 4-6 | 12 |
| Example 12 | 49.4 | 49.5 | 49.3 | 49.7 | 49.8 | 50 | >8 | 11 |
| Example 13 | 48.7 | 49 | 48.6 | 48.5 | 49 | 50 | >8 | 9.5 |
| Example 14 | 50 | 50 | 50.1 | 50.3 | 50.3 | 50.8 | >8 | 10.5 |
| Example 15 | 48.6 | 49.1 | 49 | 48.8 | 49.6 | 49.6 | >8 | 11 |
| Example 16 | 47.2 | 47.4 | 47.7 | 46.9 | 48.7 | 49.4 | >8 | 9.5 |
| Example 17 | 48.6 | 48.9 | 49 | 49 | 49.4 | 49.1 | >8 | 11 |
| Example 18 | 49.2 | 49 | 48.8 | 49 | 49.7 | 50.2 | >8 | 10 |
| Example 19 | 46.9 | 47.2 | 47.1 | 47.5 | 47.9 | 47.8 | >8 | 9 |

The post-exposure longevity of the latent image depends on the balance of novolac binders, but in general it is improved within the range of 2.5-7.5% P8ND poly(vinyl phenol). With Example 11 (low level of D_PD-1646), 2.5% P8ND is not sufficient to achieve more than 6 hours stability. However, stability is improved past 8 hours with 5 to 7.5% P8ND (Examples 12 and 13). At higher D_PD-1646 content levels, the 8×8 dots show >8 hours stability. In general, around 5% poly(vinyl phenol) is desirable to achieve the best post-imaging latitude.

### Example 20

A coated plate from Example 12 was imaged in the TRENDSETTER platemaker at 10.5 W and 175 rpm. This plate was immediately developed in an AEON processor using AEON developer at 24° C./24 seconds immersion time, rinsing with water, and gumming with AEON Finisher/Preserver. The developed plate had a dot range of at least 2 to 98% and no obvious background toning. The plate was run on a Heidelberg GTO press using Titan Process Black ink and Emerald JRB fountain solution. The plate rolled up quickly with no scumming in the non-printing areas and printed with good image density and dot range for 250 impressions.

### Example 21

Example 20 was repeated with a plate from Example 14, imaged at 10.5 W/175 rpm in the TRENDSETTER platemaker. The plate developed with similar image quality, and also rolled up quickly and printed to 250 sheets under the same printing conditions.

### Example 22

Example 20 was repeated with a plate from Example 15, imaged at 10.5 W/175 rpm in the TRENDSETTER platemaker. The plate developed with similar image quality, and also rolled up quickly and printed to 250 sheets under the same printing conditions.

### Example 23

Example 20 was repeated with a plate from Example 17, imaged at 12 W/175 rpm in the TRENDSETTER platemaker. The plate developed with similar image quality, and also rolled up quickly and printed to 250 sheets under the same printing conditions.

### Examples 24-27

Several compositions were prepared according to formulation Table 12 below. These were coated, dried and seasoned in the same manner as Examples 1-5, also on the same PVPA-treated substrate. For Examples 24-27, several different grades of poly(vinyl phenol) were evaluated, and their properties are listed in Table 12.

TABLE 12
Coating Fluids for Examples 24-27

| | Stock | Comparative | Example | Example | Example |
|---|---|---|---|---|---|
| | % | Example 24 | 25 | 26 | 27 |
| Reagent | | | | | |
| SPN 452 | 41.7 | 7.07 | 6.68 | 6.68 | 6.68 |
| P8ND (PVPh) | 20 | 0.00 | 1.25 | 0.00 | 0.00 |
| P25ED (PVPh) | 20 | 0.00 | 0.00 | 1.25 | 0.00 |
| PB5E (PVPh) | 20 | 0.00 | 0.00 | 0.00 | 1.25 |
| D_PD-1646 | 30 | 4.92 | 4.64 | 4.64 | 4.64 |
| S 0094 | 2 | 7.50 | 7.50 | 7.50 | 7.50 |
| Oil Blue N | 2 | 5.00 | 5.00 | 5.00 | 5.00 |
| Tego Glide 410 | 5 | 0.50 | 0.50 | 0.50 | 0.50 |
| Silikoftal HTT | 10 | 2.00 | 2.00 | 2.00 | 2.00 |
| Irgacure 250 | 10 | 1.00 | 1.00 | 1.00 | 1.00 |
| Dowanol PM | | 22.01 | 21.44 | 21.44 | 21.44 |
| total mass | | 50 | 50 | 50 | 50 |
| % solids | | 10 | 10 | 10 | 10 |
| solid mass | | 5 | 5 | 5 | 5 |
| % cosolvent | | 0 | 0 | 0 | 0 |
| Dry film % | | | | | |
| solids | | | | | |
| SPN 452 | | 59 | 55.67 | 55.67 | 55.67 |
| P8ND (PVPh) | | | 5 | 0 | 0 |
| P25ED (PVPh) | | | | 5 | |
| PB5E (PVPh) | | | | | 5 |
| D_PD-1646 | | 29.5 | 27.83 | 27.83 | 27.83 |
| S 0094 | | 3 | 3 | 3 | 3 |
| Vic Blue BO | | 2 | 2 | 2 | 2 |
| Tego Glide 410 | | 0.5 | 0.5 | 0.5 | 0.5 |
| Silikoftal HTT | | 4 | 4 | 4 | 4 |
| Irgacure 250 | | 2 | 2 | 2 | 2 |

Example 25 repeats Example 15. An exposure dose was chosen for each plate (based on results from Example 15), which was then subjected to an image stability test, as previously described. Table 13 shows the resulting figures for post-exposure latitude.

TABLE 13
Post-exposure latitude for Examples 24-27

| | 8 × 8 50% Equivalent to 212 lpi | | | | | | | |
|---|---|---|---|---|---|---|---|---|
| | | | | | | | Time before | |
| | | | | | | | background not | Exposure |
| Formulation | T = 0 | T = 1 hr | T = 2 hr | T = 4 hr | T = 6 hr | T = 8 hr | developed (hr) | (W) |
| Comparative | 50.5 | 51.0 | 51.1 | 51.1 | plugged | plugged | 4-6 | 11 |
| Example 24 | | | | | | | | |
| Example 25 | 48.6 | 49.1 | 49.1 | 48.9 | 49.4 | 49.5 | >8 | 11 |
| Example 26 | 49.8 | 50.2 | 50.2 | 50.2 | 50.2 | 50.6 | >8 | 11 |
| Example 27 | 50.0 | 50.6 | 50.4 | 50.4 | 50.4 | 50.8 | >8 | 11 |

Comparative Example 24 exhibits toning in the background and between dots within 4-6 hours, while such toning is absent in Examples 25-27 even after 8 hours following exposure. Dot quality is not degraded significantly after 8 hours.

Although the present invention has been described with reference to specific details, it is not intended that such details should be regarded as limitations upon the scope of the invention, except as and to the extent that they are included in the accompanying claims.

What is claimed is:

1. A method of imaging a lithographic printing member, the method comprising the steps of:
providing a lithographic printing member comprising:
(a) a hydrophilic first layer; and
(b) disposed over the first layer, an oleophilic imaging layer having (i) a resin phase consisting essentially of a major amount of alkali-soluble novolac resin and a minor amount of vinyl phenol component including one or more poly(vinyl phenol) polymers or copolymers combined with one or more vinyl phenol monomers, the vinyl phenol component being present in an amount ranging from 1% to 25% by weight of dry film, and (ii) dispersed within the cured resin phase, a near-IR absorber;
exposing the printing member to infrared imaging radiation in an imagewise pattern to render the imaging layer vulnerable to the action of a developer where so exposed; and
subjecting the printing member to a developer to remove only exposed portions of the imaging layer.

2. The method of claim 1 wherein the imaging radiation has fluence between 100 and 250 mJ/cm².

3. The method of claim 1 wherein the imaging radiation has fluence between 125 and 200 mJ/cm².

4. The method of claim 1 wherein the developer has a pH between 12.5 and 14.

5. The method of claim 1 wherein the first layer is an aluminum sheet.

6. The method of claim 1 wherein the near-IR absorber is a dye present at a level ranging from 0.5 to 5% of dry film.

7. The method of claim 1 wherein the alkali-soluble novolac resin is a cresol novolac resin.

8. The method of claim 1 wherein the alkali-soluble novolac resin is a novolac based on cresol and at least one other monomer.

9. The method of claim 1 wherein the vinyl phenol component consists essentially of a homopolymer or copolymer of 4-vinylphenol.

10. The method of claim 1 wherein the vinyl phenol component is present in an amount ranging from 2.5% to 7.5% by weight of dry film.

11. The method of claim 1 wherein the oleophilic imaging layer further comprises a development inhibitor.

12. The method of claim 1 wherein the oleophilic imaging layer further comprises a visible dye.

13. A lithographic printing member comprising:
a hydrophilic first layer; and
disposed over the first layer, an oleophilic imaging layer having (i) a resin phase consisting essentially of a major amount of alkali-soluble novolac resin and a minor amount of vinyl phenol component including one or more poly(vinyl phenol) polymers or copolymers combined with one or more vinyl phenol monomers, the vinyl phenol component being present in an amount ranging from 1% to 25% by weight of dry film, and (ii) dispersed within the cured resin phase, a near-IR absorber.

14. The printing member of claim 13 wherein the first layer is an aluminum sheet.

15. The printing member of claim 13 wherein the near-IR absorber is a dye present at a level ranging from 0.5 to 5% of dry film.

16. The printing member of claim 13 wherein the alkali-soluble novolac resin is a cresol novolac resin.

17. The printing member of claim 13 wherein the alkali-soluble novolac resin is a novolac based on cresol and at least one other monomer.

18. The printing member of claim 13 wherein the vinyl phenol component consists essentially of a homopolymer or copolymer of 4-vinylphenol.

19. The printing member of claim 13 wherein the vinyl phenol component is present in an amount ranging from 2.5% to 7.5% by weight of dry film.

20. The printing member of claim 13 wherein the oleophilic imaging layer further comprises a development inhibitor.

21. The printing member of claim 13 wherein the oleophilic imaging layer further comprises a visible dye.
